(19) United States
(12) Patent Application Publication
(10) Pub. No.: US 2006/0253352 A1
(43) Pub. Date: Nov. 9, 2006

(54) Method and system for investing through purchase of faux stones

(76) Inventor: Thomas A. Liguori, Poway, CA (US)

Correspondence Address: PILLSBURY WINTHROP SHAW PITTMAN LLP, P.O BOX 10500, McLean, VA, 22102, US

(21) Appl. No.: 11/116,978

(22) Filed: Apr. 28, 2005

(51) Int. Cl. G06Q 40/00

(52) U.S. Cl. 705/35; 705/37

(57) ABSTRACT

A method and system for providing an investment opportunity whereby investors are provided a positive return on their investment, while, at the same time, receiving the benefit of an imitation stone that satisfies their required criteria in a precious stone includes identifying a prospective purchaser of a precious stone and, based on the total amount of money that the purchaser is willing to spend, offering an imitation stone for a fraction of the price, and investing the remainder with a predetermined rate of return. The money is invested through an investment entity, with a central administrator facilitating the transactions and receiving a percentage from the investment entity. Various retailers of stones may perform the actual sale to the purchaser in return for a commission from the central administrator. In addition, aspects of the invented method and system may be computerized, including electronic communication among the various entities within a network.

### FIELD OF INVENTION

This invention relates generally to providing investment opportunities to investors and, more specifically, to identifying potential investors as prospective purchasers of precious stones who are willing to accept (and pay for) an imitation stone and have the remainder of their allotted finds be invested at a predetermined rate of return.

### BACKGROUND OF THE INVENTION

It is well-known that businesses and other ventures often seek investors who have the present ability to depart with a certain amount of money, for a given period of time, and in return, receive certain benefits in the future. The magnitude of the future benefit may generally depend on the amount of money invested, the length of time for the investment, and the level and type of risk, or uncertainty, that the investor is willing to accept.

It is also well-known that individuals who are in the market to purchase a precious stone, e.g., a diamond, ruby, sapphire, emerald, etc., have generally made a decision to spend a sizeable amount of money in purchasing the stone. However, even though most consumers may consider the purchase of precious stones to be a wise investment, there is a large amount of uncertainty associated with actual worth, the liquidity, and the appreciation in value of a precious stone.

More specifically, the valuation of precious stones, such as, e.g., diamonds, in general, is fairly subjective. As such, consumers rarely, if ever, really know whether they are over-paying for a specific diamond, or whether they are “getting a good deal”. In addition, even when a consumer feels that he/she has paid a fair price in acquiring a specific stone, he/she has no way of really knowing whether, and to what extent, the stone has appreciated over time. Moreover, a re-sale market for such stones is not generally available. For these reasons, it is often difficult for consumers to liquidate their precious stone if they so desire.

Thus, although prospective purchasers of a precious stone represent a group of individuals who have already decided to depart with, or “invest”, a considerable amount of money, the choice as to the means for investment, e.g., the stone, is generally made as an emotional decision, and not necessarily one that is financially sound vis-à-vis a long-term investment. A need, therefore, exists for a method and system by which individuals willing to invest an amount of money are identified and provided with an overall investment product that is both emotionally satisfying and financially sound.

The features and advantages of the present invention will become more apparent through the following description. It should be understood, however, that the detailed description and specific examples, while indicating particular embodiments of the invention, are given by way of illustration only and various modifications may naturally be performed without deviating from the spirit of the present invention.

### BRIEF DESCRIPTION OF THE DRAWING

FIG. 1 shows an illustration of communication links and potential interaction established among individuals, entities, equipment, and/or electronic computers that may be used in the practice of an embodiment of the present invention.

### DETAILED DESCRIPTION

To address the above-mentioned issues, an embodiment of the present invention is directed to providing an investment vehicle for the consumer by offering to the consumer an imitation stone, e.g., an imitation diamond, ruby, sapphire, emerald, etc., whereby the consumer will be provided with a specific rate of return on his/her investment.

Certain features of an embodiment of the present invention may be described with reference to the illustrative example that follows. It is noted that, in the present application, a diamond is used as the means by which a potential investor is identified. However, such use is for illustrative purposes only, and other precious stones, for which imitations, or substitutes, are readily available, may also be used in conjunction with the other features of the invention described herein. In addition, the terms “consumer” and/or “investor” are used to refer, generically, to a purchaser, or buyer, whether the purchase (of the imitation stone) is to be made in person (e.g., at a retail store), over the Internet (or similar media), through mail order, or. otherwise.

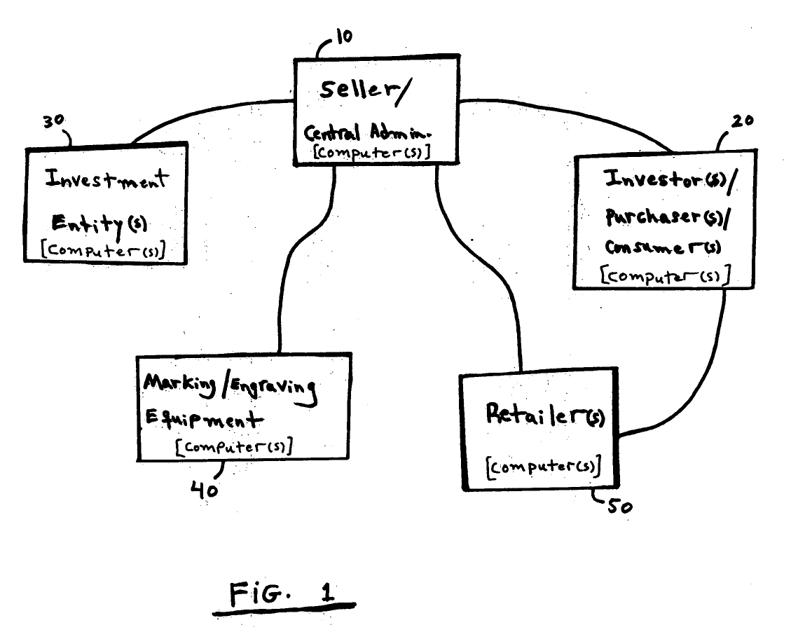

As shown in FIG. 1, the present invention involves the flow of information among several entities, including some or all of: (1) a seller 10, who may be a seller of both precious (i.e., actual) stones and imitation stones, wherein the seller functions as the central administrator, or clearinghouse, for the process according to embodiments of the invention; (2) one or more investors, or purchasers, 20, who wish to spend a specified amount of money to purchase a precious stone; (3) one or more investment entities 30; (4) one or more retailers 50 of precious and/or imitation stones; and (5) marking equipment 40, such as, e.g., an engraving machine, that may be used to individually mark each stone for each respective purchaser 20.

In one embodiment, the process according to the present invention is initiated when the seller 10 identifies a consumer 20 who is considering buying a precious stone (such as, e.g., a diamond) for a specified amount of money, e.g., $10,000.00. Having identified a purchaser who has already made the decision to depart with $10,000.00, the seller 10 then offers to the purchaser 20 an imitation diamond of the purchaser's choice that costs, e.g., $500.00. The goal, from the seller's point of view, is to offer to the purchaser 20 an imitation diamond that looks and feels as close to the actual diamond that the purchaser 20 had originally sought, so as to fulfill the purchaser's emotional, or sentimental, criteria and, at the same time, enable the purchaser 20 to invest the remainder of his/her money in an investment vehicle other than a diamond.

Thus, in the above example, assuming that imitation diamonds do not cost more than $1000.00, the purchaser 20 would potentially have at least $9,000.00 left over (i.e., the “remainder”) that could be invested. With this in mind, the seller 10 then presents the purchaser 20 with one or more investment options for investing the remainder, wherein each option carries a different rate of return depending, e.g., on the amount of money being invested and the period of investment.

For example, the seller 10 may offer: (1) a 4% rate of return if the purchaser 20 agrees to invest $5,000.00 through the seller 10 for a period of 5 years; (2) a 5% rate of return if the purchaser 20 agrees to invest between $9,000.00 and $9,500.00 through the seller 10 for a period of 5 years; and (3) a 4% rate of return if the purchaser 20 agrees to invest between $9,000.00 and $9,500.00 through the seller 10 for a period of 3 years.

Thus, in the above example, assuming the purchaser 20 is willing to invest the entirety of the remainder and to maximize his/her rate of return, he/she would agree to buy the imitation diamond that costs $500.00 and invest the remaining $9,500.00 in option (2), with a 5% rate of return. In other words, the purchaser 20 would pay to the seller 10 the sum of $10,000.00 in return for the imitation diamond, plus a certificate that indicates that, if the purchaser 20 leaves his/her $9,500.00 untouched for the period of 5 years, then, at the end of the five years, he/she can redeem the certificate for the face value thereof, which will reflect the predetermined rate of return of 5%.

Thus, from the consumer's point of view, the “front end” of the method and system of the present invention operates as an annuity, or similar investment product, in order to provide the purchaser 20 with a fixed or predetermined rate of return over an agreed-upon period of time. In the “back end”, the seller 10 must invest the $9,500.00 remainder in such a way that, at the end of the agreed-upon term (e.g., five years in the above example), the actual value of the principal plus interest of the remainder will be higher than the face value of the certificate to be issued to the purchaser 20. Put another way, the seller 10 must be able to invest the remainder in such a way as to earn a higher rate of return than that which is promised to the purchaser 20; the difference will constitute the seller's profit.

According to an embodiment of the invention, in order to achieve the above-mentioned goal, the seller 10 contracts with an insurance company, brokerage company, investment company, or other similar entity (generally referred to as “investment entity” 30) which actually takes and invests the remainder, and is the actual guarantor of the purchaser's rate of return. In this way, the seller 10 may be thought of as a “broker”, whose commission is constituted by the difference between: (1) the rate of return that the investment entity 30 is willing to provide to the seller 10 (i.e., an “ultimate” rate of return) and (2) the rate of return that the seller 10 can negotiate with the purchaser 20.

In practice, given that the investment options offered to the purchaser 20 provide higher rates of return for longer periods of investment, the contract between the seller 10 and the purchaser 20, as well as that between the investment entity 30 and the seller 10, may include penalty provisions for early redemption. Thus, in the above example, if the purchaser 20, having chosen option (2), decides to redeem his/her certificate after three years rather than waiting for the agreed-upon five-year period to expire, then the investment entity 30 may charge the seller 10 a penalty (for early withdrawal) which, in turn, may be passed on to the purchaser 20. The penalty may be calculated on a sliding scale, on a flat-rate basis, or on any other basis generally known in the art.

In one embodiment, the transactions described above are computerized, and may take place over the Internet. In such an embodiment, FIG. 1 represents an electronic network, in which the reference numbers refer to, e.g., computers used at each node to establish communication among the various individuals, entities, and/or equipment.

In operation, in a computerized embodiment, the seller 10 creates a web site which includes pictures and descriptions of various pieces of imitation stones, such as, e.g., diamonds in the illustrative example used herein. The purchaser 20 contacts the seller's site through means generally known in the art, e.g., through the purchaser's computer, cellular phone, hand-held device, or other means of communication over a network. Here, as before, the seller 10 also provides one or more investment options to the purchaser 20.

Once the purchaser 20 decides on a specific (imitation) diamond, as well as the amount of the remainder that the purchaser 20 is willing to invest, the purchaser provides certain required information to the seller 10, and enters into an online agreement to purchase the imitation diamond for its stated price, and to pay that price, in addition to the remainder amount, to the seller 10. The payment may be achieved electronically, or through more traditional means such as, e.g., sending a check to the seller 10.

Based on the information collected, which may include the purchaser's contact information, credit card number, etc., and the specific imitation diamond and investment option chosen by the purchaser 20, the latter is then issued a receipt promising delivery of the diamond, as well as the certificate evidencing investment of the remainder, within a given number of days.

Once the seller 10 has received the funds, e.g., the $10,000.00 in the above example, the seller's computer 10 then may either download the information gathered from the purchaser 20 in order to provide hardcopies of pertinent information to the investment entity 30, or it may automatically forward the information electronically to the investment entity's computer 30. The investment entity 30 will then issue a certificate in the purchaser's name, indicating a rate of return (to be paid to the purchaser 20) that has been previously negotiated between the investment entity 30 and the seller 10. Again, this may be sent to the seller 10 in hard copy, or to the seller's computer (or other reception device) 10 via electronic transmission.

In one embodiment, once the seller 10 receives the certificate information, the latter is input into the seller's computer (if the certificate information was not received electronically), which then communicates the information to a marking apparatus 40. The latter may be, e.g., a laser-engraving machine, or other machine capable of affixing identifying indicia onto the imitation diamond. When an engraving machine, e.g., is used, the machine engraves the policy number (for the purchaser's investment) and/or other identifying information onto the diamond. In this way, the purchaser 20 will not be at risk of losing the entirety of his/her investment should the diamond and/or the certificate be lost. The seller 10 then sends the engraved diamond and the certificate to the purchaser 20.

In an alternative embodiment, the present invention may include a “point-of-sale” element. Here, one or more retailers 50 may contract with the seller 10 to sell an imitation diamond, along with an investment policy, to a purchaser 20 who may walk into the retailer's store, or otherwise contact the retailer 50, e.g., through a web site set up by the retailer 50. In order to clarify the scope of the invention, the term “walk-in purchaser” may be used to refer to purchasers who buy the diamond and investment policy through the retailer 50, regardless of whether such purchasers actually physically visit the retailer's store, or simply contact the retailer via a website, etc.

In return for the sale, the retailer 50 may receive a commission (e.g., at a per-sale flat rate, or based on the future value of the annuity, etc.) from the seller 10. As before, the seller 10 negotiates a rate of return with one or more investment entities 30, wherein the seller's profit is equal to the ultimate (rate of) return provided by the investment entity 30 to the seller 10, minus the commission paid by the seller 10 to the retailer 50 and the (rate of) return paid by the seller 10 to the walk-in purchaser 20.

As with the embodiments that were discussed previously, the embodiment described immediately above may also be either partially or entirely computerized. Thus, for example, the purchaser 20 may contact the retailer 50 electronically, and the retailer 50 may then transmit the purchaser's information to the seller's computer 10. Regardless, however, once the sale has been finalized, the retailer 50 may send the purchaser's imitation diamond to the seller 10 who, upon receipt of the funds to be invested on behalf of the purchaser 20, proceeds as outlined previously.

It is known, in general, that the rate of return is directly proportional to the amount of investment, such that an investment entity may provide a higher rate of return for larger investments by the seller 10. Therefore, in embodiments of the invention, the seller 10 may pool the remainder amount, or investment funds, from a plurality of purchasers 20 and invest the resulting total investment amount through the investment entity 30 so as to receive a higher ultimate rate of return from the investment entity 30. This may be specially applicable where the investment entity 30 sets sequential thresholds for paying progressively higher rates of return.

While the description above refers to particular embodiments of the present invention, it will be understood that modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A method of investing funds to provide a predetermined rate of return to an investor, said method comprising:
(a) identifying said investor as a prospective purchaser of a precious stone;
(b) determining the total amount of money that the purchaser is willing to pay for said precious stone;
(c) agreeing, by the purchaser, to buy from a seller an imitation stone in place of said precious stone for a specified purchase price that is a fraction of the precious stone's price;
(d) providing a computer system to perform the steps of:
calculating the difference between said total amount of money and said imitation stone's purchase price, said difference being equal to the net amount of funds available for investment on behalf of said purchaser; and
providing, based on the value of said net amount of funds, one or more investment options for investing said net amount, the one or more investment options including as a feature thereof a respective rate of return to the purchaser;
(e) agreeing, by the purchaser, to have said net amount of funds invested in at least one of said investment options; and
(f) selling the imitation stone to the purchaser for said purchase price and investing said net amount of funds in said at least one of the investment options.

2. The method of claim 1, further including agreeing, by the purchaser, to forego access to the invested funds for a predetermined period of time.

3. The method of claim 2, wherein the purchaser agrees to pay a penalty for withdrawal of said invested funds prior to the termination of said predetermined period of time.

4. The method of claim 3, wherein the computer system further performs the step of calculating the amount of said penalty.

5. The method of claim 1, wherein said net amount of funds is invested at an ultimate rate of return that is higher than the rate of return to be paid to the purchaser.

6. The method of claim 1, further including investing, by the seller, said net amount of funds through a third-party entity, said entity agreeing to pay to the seller an ultimate rate of return.

7. The method of claim 6, wherein the ultimate rate of return to be paid to the seller by said third-party entity is higher than the rate of return to be paid by the seller to the purchaser.

8. The method of claim 6, wherein the third-party entity is at least one member selected from the group consisting of an insurance company, a brokerage company, and an investment company.

9. The method of claim 6, further including investing a total amount of funds by pooling the net amount of funds to be received from each of a plurality of purchasers.

10. The method of claim 9, wherein said ultimate rate of return is calculated as a function of the total amount of funds.

11. The method of claim 6, wherein the seller is in electronic communication with said third-party entity.

12. The method of claim 1, wherein said precious stone is a member selected from the group consisting of a diamond, a sapphire, a ruby, and an emerald.

13. The method of claim 1, further including issuing to the purchaser a certificate evidencing the terms of the purchaser's investment.

14. The method of claim 1, wherein the seller is in electronic communication with the purchaser.

15. In an electronic network including a seller of imitation stones, a prospective purchaser of a precious stone, and an investment entity, a method for offering investment opportunities to the purchaser, said method comprising:
(a) providing, by the seller, a website to present various imitation stones for sale;
(b) accessing, by the purchaser, said website and agreeing to buy an imitation stone in place of the precious stone for a purchase price specified on said web site;
(c) calculating a net investment amount as the difference between the amount of money that the purchaser would have paid for the precious stone and the specified purchase price of the imitation stone;
(d) presenting to the purchaser, based on the value of the net investment amount, one or more investment options for investing said net amount;
(e) agreeing, by the purchaser, to have said net investment amount invested in at least one of said investment options;
(f) collecting and forwarding to the investment entity information relating to the purchaser and the at least one investment option; and
(g) issuing, by the investment entity, a certificate evidencing the terms of the purchaser's investment, said terms including a predetermined rate of return to the purchaser.

16. The method of claim 15, wherein, for each investment option, said rate of return is predetermined by agreement between the seller and the investment entity.

17. The method of claim 16, wherein the investment entity agrees to pay an ultimate rate of return to the seller that is higher than the rate of return to be paid to the purchaser.

18. The method of claim 15, wherein the investment entity is at least one member selected from the group consisting of an insurance company, a brokerage company, and an investment company.

19. The method of claim 15, further comprising:
receiving, by the seller, the certificate issued by the investment entity, including a policy number;
providing, by the seller, at least the policy number to a marking apparatus so as to have the policy number indicated on the imitation stone; and
sending the marked imitation stone and the certificate to the purchaser.

20. The method of claim 19, wherein the marking apparatus is a laser engraving machine.

21. The method of claim 19, wherein the policy number is electronically transmitted to the marking apparatus.

22. The method of claim 15, wherein the purchaser agrees to forego access to the net investment amount for a predetermined period of time and to pay a penalty for withdrawals made prior to the termination of said predetermined period of time.

23. The method of claim 15, wherein the network includes a plurality of purchasers, and the seller pools the net investment amount to be invested by each respective purchaser and invests the resulting total investment amount through the investment entity.

24. The method of claim 23, wherein the investment entity agrees to pay an ultimate rate of return to the seller that is higher than the rate of return to be paid to each respective purchaser, and said ultimate rate of return is calculated as a function of the total investment amount.

25. The method of claim 15, wherein said precious stone is a member selected from the group consisting of a diamond, a sapphire, a ruby, and an emerald.

26. The method of claim 15, wherein said network is the Internet.

27. The method of claim 15, wherein a retailer of stones agrees to sell an imitation stone and an investment policy to a walk-in purchaser on behalf of said seller in return for a commission from the seller.

28. The method of claim 27, wherein the commission is based on a per-sale flat rate.

29. The method of claim 27, wherein the commission is based on the face value of the investment policy.

30. The method of claim 27, wherein the retailer is in electronic communication with the seller.

31. The method of claim 27, further comprising:
forwarding to the seller, by the retailer, the imitation stone sold to the walk-in purchaser;
receiving, by the seller, a certificate issued by the investment entity, including a policy number;
providing, by the seller, at least the policy number to an engraving machine so as to have the policy number engraved on the imitation stone; and
sending the engraved imitation stone and the certificate to the walk-in purchaser.

32. The method of claim 31, wherein the policy number is electronically transmitted to the machine.

33. The method of claim 27, further comprising:
pooling, by the seller, the net investment amount to be invested by said prospective purchaser and the amount to be invested by said walk-in purchaser; and
investing the resulting total investment amount through the investment entity.

34. The method of claim 33, wherein the investment entity agrees to pay an ultimate rate of return to the seller that is higher than the rate of return to be paid to said prospective purchaser and higher than a rate of return to be paid to the walk-in purchaser, and said ultimate rate of return is calculated as a function of the total investment amount.
